(19) United States
(12) Patent Application Publication
(10) Pub. No.: US 2023/0055660 A1
(43) Pub. Date: Feb. 23, 2023

(54) SECURE DATA MANAGEMENT

(71) Applicant: Hewlett-Packard Development Company, L.P., Spring, TX (US)

(72) Inventors: Thalia May Laing, Bristol (GB); Adrian John Baldwin, Bristol (GB)

(73) Assignee: Hewlett-Packard Development Company, L.P., Spring, TX (US)

(21) Appl. No.: 17/799,945

(22) PCT Filed: Mar. 6, 2020
(86) PCT No.: PCT/US2020/021361

§ 371 Date: Aug. 16, 2022

(51) Int. Cl. G06F 21/33

(52) U.S. Cl. CPC G06F 21/33

(57) ABSTRACT

In an example there is provided a method, comprising generating a token in response to an interaction between a user device associated to a user and a service device associated to a service. The token comprises record data indicative of the interaction and verification data to verify the record data. The token is communicated to the user device. The token is stored at the service device. The verification data is generated on the basis of the record data and identification data associated to the user.

### BACKGROUND

Throughout the course of a day, a user device such as a smartphone may interact with large numbers of devices outside the control of the device owner. Interactions between user devices and non-user devices may involve the sharing of data between the devices. Increasingly, service providers are also connecting everyday devices and objects to the internet. Connecting everyday devices in this way gives service providers opportunities to provide improved features and user experiences.

### BRIEF DESCRIPTION OF THE DRAWINGS

FIG. 1 is a schematic diagram showing an apparatus for performing an action on data, according to an example.

FIG. 2 is a block diagram showing a method for generating a token, according to an example.

FIG. 3 shows a processor associated with a memory comprising instructions for storing a token, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In recent years, everyday electronic devices are increasingly connected to the internet. Devices that are connected to the internet are sometimes referred to as forming the Internet-of-Things (IoT). A user may be able to interact with loT devices using their own smart devices. Companies and service providers offer services to users through IoT devices. For example, a user may be able to connect their phone to a photobooth to upload photos to be printed, or a user may be able to connect their phone to a speaker in a hotel room to play music.

Service providers often store personal data from interactions with service devices under the control of the provider. The collection of personal data associated to a user allows service providers to analyse or improve the user experience for future interactions with service devices. In some cases, service providers store data in remote data storage.

Over time a user device interacts with many different services and service devices across multiple platforms and networks. It is difficult for an entity to track which services have stored data in connection with specific interactions. In particular, for the user, it may be difficult to know exactly which services and devices they have interacted with. For a service, it may be difficult to relate data stored across different servers to a particular user.

Privacy has also become a significant concern for users and service providers in recent years. A much larger volume of personal data is now being generated by user devices. A significant amount of data is also being held remotely by service providers. As well as being a concern for users, privacy issues around data management are also a concern for service providers. A data breach can be costly for a service provider and damaging for their reputation.

Some countries and legal jurisdictions have passed data protection legislation in recent year in response to evolving expectations regarding the handling of user data and user privacy. For example, in 2016 the European Union passed the General Data Protection Regulation (GDPR). Regulations such as GDPR aim to provide a simple legal framework under which service providers understand their obligations regarding the retention and handling of user data. In some cases, a service provider may be expected to perform certain actions on user data. For example, a service provider may be expected to be able to identify user data and delete the data on request by the user.

In practice implementation of such a framework may be difficult. Data is often distributed across multiple jurisdictions and may be copied or moved between physical locations over the course of time, which makes tracking and identification challenging. Data may also be transferred out to third parties. In some cases, neither the service provider nor the user will be able to identify where a user’s data is being held on request.

The methods and systems described herein give users the ability to record interactions with devices which store their personal data. The methods and systems give users the ability to request removal of their data from a service provider’s servers or to identify which personal data is stored by a service provider. The methods and systems also help the service locate the data associated with an authenticated user.

A user is notified by their device following an interaction of their device with a service device owned by the service provider. A notification may comprise a request by the service to determine whether the user would like to record the interaction. If the user records the interaction, the user device is sent a ‘token’ after the interaction. The token allows the user to track interactions they have had and who they should contact to request access or deletion of their data.

The token is stored at the user device and by the service with the personal data from the interaction of the user device with the service device. If the user wants to request deletion or access to their data the token is communicated with the request. The service can validate the token to verify that a user contacting them has interacted with one of their devices. Once the token has been validated, the service locates the personal data relating to the interaction and performs the action according to the user request.

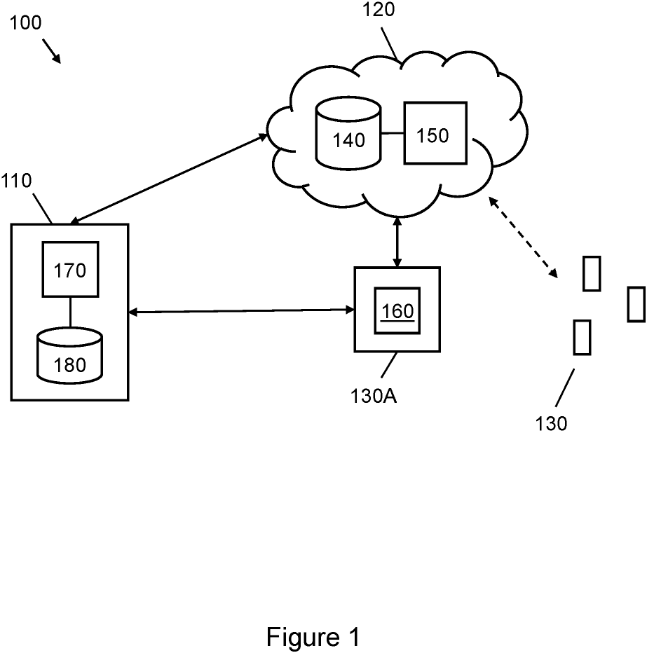

FIG. 1 shows an apparatus 100, according to an example. The apparatus 100 shown in FIG. 1 may be used in conjunction with the methods described herein.

The apparatus 100 comprises a user device 110. The user device 110 is controlled and owned by a user. The user device 110 may be a computing device such as a laptop or phone. The user device 110 is a networked device which communicates with other devices and systems across one or more networks. In examples, the user device 110 may communicate with other devices over a wireless network such as a mobile telecommunications network or Wi-Fi network.

In FIG. 1, the user device 110 is arranged to interact with a service 120. The service 120 may be any company or organisation that provides a service to the user at the user device 110. Systems and devices that are controlled and operated by the service 120 may be distributed across a large number of physical locations.

In FIG. 1, the service 120 controls a number of devices, herein referred to as service devices 130. The service devices 130 are networked devices. For example, the service devices 130 may be “smart devices” such as smart speakers, smart meters, smart cars, or smartphones.

The service devices 130 are communicatively coupled with the service 120. In particular, data is communicated between the service 120 and service devices 130 across one or more networks. Data received and/or generated by the service devices 130 may be sent to the service 120. Data stored and/or generated by the service 120 may be transmitted to the devices 130. Examples of data that may be communicated between the service 120 and service devices 130 include user data, content data and command and control data.

In FIG. 1, the user interacts with a service device 130A via user device 110. The service device 130A is a service device in the group of service devices 130 and is controlled and operated by the service 120. The user device 110 and service device 130A may be located in close proximity in physical space. For example, the service device 130A may be a printer and the user device 110 may be a smartphone. When the user enters the room with the printer, their smartphone may engage with the printer via Wi-Fi.

The user device 110 may comprise a graphical user interface to facilitate interactions between their device and service device 130A. In the previous example, where the user device 110 is a smartphone and the service device 130A is a printer, the user may be presented with information on the screen of the smartphone which prompts them to connect their device to the printer. The user can then send a command via the GUI of their device to connect to the printer.

In examples described herein, when the user interacts with the service device 130A, at least some of the data arising from the interaction of the user device 110 and the service device 130A may be logged by either or both of the service device 130A and service 120. Such data may include but is not limited to personal data relating to the user or user device, metadata, location data or content data arising from the interaction between the user device 110 and service device 130A.

The service 120 comprises a data storage 140. The data storage 140 stores data arising from the interactions of the user device 110 and service device 130A. In some cases, the data storage 140 is a distributed data storage across multiple physical locations. In other examples, the data storage 140 is a single physical data storage device.

In FIG. 1, the data storage 140 is located in the service 120. In particular, the data storage 140 is remote from the service device 130A. Examples of the methods and systems described are equally applicable to cases where the service device 130A itself stores data arising from interactions of the service device 130A and user device 110.

In some examples, both the service device 130A locally stores data and the service 120 stores data in data storage 140. For example, the service device 130A may store messages sent between the service device 130A and user device 110 during the interaction and the service 120 may create a log that an interaction happened and store the log in the data storage 140. In other cases, the service device 130A initially stores data locally and, at a later point in time, copies, backs up or transfers some or all of that data to the data storage 140 in the service 120.

In FIG. 1, the service 130 comprises a data manager 150. The data manager 150 is communicatively coupled to the data storage 140 and/or the service device 130A, via a network. According to examples, the data manager 150 is arranged to manage data stored in the data storage 140 and/or the service device 130A. The data manager 150 is arranged to perform data management operations on data including identification, erasure and/or modification of data of data entries in the data storage 140 and/or service device 130A.

In FIG. 1, the service device 130A, comprises a token generator 160. According to examples described herein, the token generator 160 may be implemented in hardware or software on the service device 130A. In some cases, the token generator 160 is implemented in a combination of hardware and software. The token generator 160 is arranged to generate tokens which are communicated to, and stored by the user device 110. A token comprises record data indicative of an interaction between the service device 130A and user device 110. The tokens allow the user to track interactions between the user device 110 and service device 130A. Furthermore, the tokens inform the user who they should contact to request access or deletion of their data. The tokens are also stored by the service 120. The tokens allow the service 120 to ascertain the identity of a user and ensure that data is not sent to a different user or deleted in error.

The token generator 160 may be coupled to a controller and network interface (not shown in FIG. 1). The controller may be implemented in hardware or software (or combination of both) on the service device 130A. The controller instructs the token generator to generate a token following an interaction of the service device 130A and user device 110. The controller transmits the token via the network interface, to the user device 110. The controller stores the token with session data from the interaction.

The token may be stored by either or both of the service device 130A and the service 120 in the data storage 140. In the case where the session data and token are to be stored remotely in the data storage 140, the controller communicates the session data and token via the network interface to the data manager 150. The user device 110 comprises a token manager 170 and token storage 180 which is communicatively coupled to the token manager 170. According to examples, the user device 110 receives a token from the service device 130A, following an interaction of the user device 110 and service device 130A.

In some cases, before receiving a token, the service device 130A may send an initiation message to the user device 110. Some of the service devices 130 may be unable to send individual messages to individual devices. In such a case, a service device 130 may be arranged to communicate a broadcast message and wait for user devices to respond.

According to examples, when the user device 110 receives the initiation message from the service device 130A, the user device may prompt the user and ask whether or not they would like a token to record the interaction. The user may decline the token. In that case, the protocol is terminated. Otherwise, if no user interaction is required or if the user accepts the initiation message, the user’s device 110 is arranged to respond to the service device 130A.

In some examples, the user device 110 may be arranged to allow the user to select a mode of operation in which tokens are automatically selected or rejected, without notifying the user. In some cases, criteria according to a user’s preferences, may be configured at the user device 110 for automatic selection and rejection of tokens. For example, the user may wish to reject all tokens from a certain device or during a certain time period in the day. The user device 110 may also store a log of interactions with the service device 130A that the user may review at a later point in time. The log may include interactions where tokens are transmitted to and/or rejected by the user device 110.

Once the user is committed to receiving a token, the user device 110 responds with a response message. In examples, the response message comprises an identifier UserDevicelD, for the user device 110. In examples, UserDevicelD is a public key associated to the user device 110. In particular, UserDevicelD may be an ephemeral or persistent public key associated to the user device 110, which is refreshed periodically. In other cases, UserDevicelD is associated with a public key via a certificate.

The service device 130A receives UserDevicelD. To respond, the service device 130A may sign the data received and communicate the signature, along with instructions for where to request removal of data, to the user device 110. In an example, the token may comprise the following data:

### UserDeviceID, ServiceName, Contact Address, Date, Signature (UserDeviceID, Date)

As previously indicated, UserDevicelD is the identifier of the user device 110. The ServiceName is a name of the service 120. According to examples, this is a human-readable name from which the user can identify the service 120. The ContactAddress is contact information the user can use to request removal of data. For example, ContactAddress may be an email address, company name and registered address, or a company registration number associated to the service 120.

In examples, Date is the date or time, location, or related information that identifies when the interaction of the user device 110 and service device 130A took place. In some cases, multiple tokens associated to a single user or user device 110 may be stored by the same service 120. The date field of the token allows tokens associated to the same user to be distinguished, where the same user keeps the same UserDevicelD throughout multiple interactions with the service.

The Signature(UserDevicelD,Date) is verification data that is generated on the basis of the Date and UserDevicelD. According to examples, the verification data may be a digital signature which is generated by the token generator 160 of the service device 130A using a private key of the service device 130A.

The token manager 170 of the user device is arranged to verify the data in the token using the verification data. For example, in the case where the verification data is a digital signature, of Date and UserDevicelD, the token manager may use the public key corresponding to the private key of the service device 130A, to verify the signature. To do this, the user device 110 may be sent the public key by the service 120 or service device 130A. In some cases, where the service device 130A is a static device, and the user device 110 is in close proximity to the device a public key may, for example, be printed on the service device 130A using a machine-readable code which the user can scan using their device.

In some cases, additional data is also included in the token. For example, the token may comprise a nonce or a counter. This data may be generated by the service 120 and used to help locate the token. For example, in some cases, the token comprises a uniform resource locator which the user can select to identify the data.

Once the token has been verified by the token manager 170 it is stored by the token manager 170 in the token storage 180. In examples, the token storage 180 may be periodically backed up to a remote service. The service device 130A also stores the token along with data recorded in the interaction.

In some cases, where data arising from the interaction is held remotely on the data storage 140, the service device 130A may communicate the token to the data manager 150 of the service 120. The data manger 150 stores the token with data recorded by the service device 130A, and stored in the data storage 140 of the service 120.

At a future point in time, the user of user device 110 wishes to request access and/or deletion of data held by the service 120. In examples described herein, to perform such a request, the token manager 170 is arranged to retrieve the relevant token from the token storage 180. A particular token may be identifiable on the basis of a particular data field such as ServiceName or Date. The user may input a search request to identify tokens on the basis of data stored in the tokens.

According to examples, once the user has located the token or tokens relevant to the interaction, they use the token to identify the contact information contained within the token. The user follows the contact information and sends the token they received to the service 120, possibly via the service device 130A, with a request to perform an action. The request is a request to perform an action on the data associated with the UserDevicelD in the token, and a digital signature on the request and token, signed, using a private key associated to the public key corresponding to UserDevicelD. The signature ensures that the user device 110 is in possession of the token and is the same device that is related to UserDevicelD.

The service 120 verifies the signature on the request, using UserDeviceID in the case where UserDevicelD is a public key or, in other cases, using the public key corresponding to UserDevicelD. If satisfied, the service 120 uses the token to locate the data relating to the interaction. A successfully verified signature authenticates the user and gives the service 120 certainty that the user is the same user that originally interacted with the service.

The service 120 performs the action according to the request. The action may be a request to communicate the original data from the interaction to the user or to delete data from the interaction. This may involve retrieving data that is stored on one or both of the service device 130A and in the data storage 140. Accordingly, the data manager 150, may interact with the one or both of the service device 130A and data storage 140 to locate all the data relevant to the request. In some cases, the service 120 sends a receipt to confirm that all the relevant data associated with the token has been located or deleted.

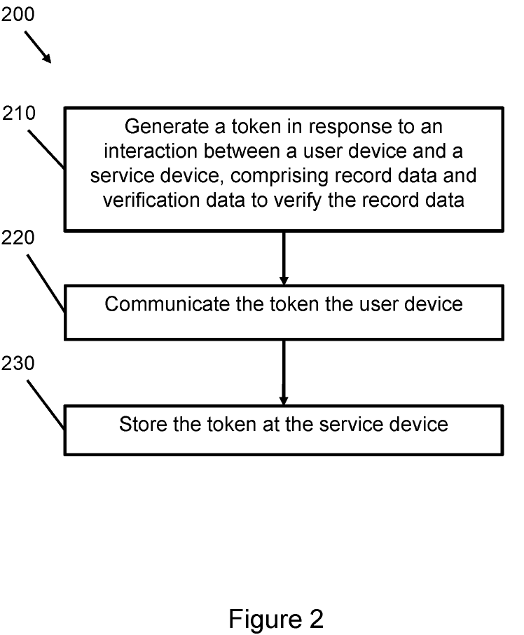

FIG. 2 is a block diagram showing a method 200 according to an example. The method 200 shown in FIG. 2 may be used in conjunction with the apparatus 100 shown in FIG. 1. In particular, the method 200 may be implemented on the service 120 and service 130A shown in FIG. 1.

At block 210, a token is generated in response to an interaction between a user device, such as user device 110, associated to a user and a service device, such as service device 130A, associated to a service. The token comprises record data indicative of the interaction and verification data to verify the record data. According to examples herein, the verification data is generated on the basis of the record data and identification data associated to the user.

At block 220, the token is communicated to the user device. At block 230, the token is stored at the service. In some cases, the token is stored by the service device itself. In other cases, the service stores the token remotely from the service device.

In examples described herein the method 200 may further comprise, receiving a message from the user device comprising a request to perform an action on data stored by the service and a token. The method may comprise verifying the request and accessing data stored by the service on the basis of record data contained in the token. In examples, the method comprises performing the action according to the request. The action may comprise communicating data to the user device and/or deleting data stored by the service and associated to the interaction.

In some cases, the request further comprises authentication data. The authentication data authenticates the request. Accordingly, verifying the request may comprise verifying the authentication data. The authentication data may comprise a digital signature generated using a private key of the user device. Accordingly, verifying the request comprises verifying the digital signature of the request using a public key corresponding to the private key of the user device.

The method 200 may further comprise transmitting an initiation message to the user device and generating the token on the basis of a response to the initiation message.

According to examples, the tokens generated by the service device 130A may be valid for a particular period, or have an expiry date after which time the token may no longer form part of a request. In some cases, an expiry period may be tied to a period associated with the service. For example, if a service keeps personal data for two years, a token may expire after two years.

Where a user has multiple interactions with a single service, the token manager may store an identifier for this service, and receive multiple tokens corresponding to a single UserDevicelD. Using the methods and systems described herein, a user may send a request to the service 120 for an action to be performed on all data relating to all the tokens. The service may find all the personal data relating to the UserDevicelD rather than one specific token and perform the action.

In the examples of the methods and systems described herein, interactions are described as taking place between a user device 110 and service device 130A. The methods and systems are also applicable to manage remote interactions between a user device 110 and remote device which is physically separated from the user device 110 or a software application controlled by the service 120. In some cases, rather than a physical device, the service “device” 130A may effectively be considered a service which performs token generation according to the methods described herein. In other cases, the service device 130A is a platform, such as a social media platform, which collects data and links the user to one or more applications that the user interacts with through the user device 110.

The methods described allow users to record interactions with service devices that may be storing their personal data. Interactions are stored alongside contact details, which the user can use to request access to or deletion of their data. When a user requests access to or deletion of their data, the service knows that the user definitely interacted with their service device because the user presents a valid, signed token. The service knows that the request to comes from the entity that received the token during the interaction, as the user demonstrates ownership of the associated private key by signing the request to the service. Using the token, the service can identify all information relating to a specific interaction that is located on the service device or a database. Advantageously, the methods and systems described herein improve user privacy and security from the point of view of the service.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

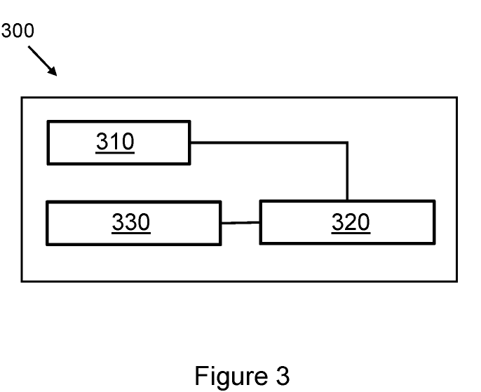

For example, the instructions may be provided on a non-transitory computer readable storage medium encoded with instructions, executable by a processor. FIG. 3 shows an example of a processor 310 associated with a memory 320. The memory 320 comprises computer readable instructions 330 which are executable by the processor 310.

The instructions 330 cause the processor to identify, from data received at a first device, a token comprising log data indicative of an interaction between the first device and a second device, and verification data. The instructions further cause the processor to verify the log data on the basis of the verification data and store the token at the first device. The verification data is generated on the basis of the log data and identification data associated to the first device.

In some examples, the instructions 330 cause the processor 310 to access a token stored at the first device, on the basis of log data associated to an interaction between the first and second device, and transmit the token with a request to perform an action on data stored by the second device in respect of the interaction between the first and second device. The instructions 330 may further cause the processor 310 to generate authentication data on the basis of the token and communicate the authentication data to the second device with the request.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
generating a token in response to an interaction between a user device associated to a user and a service device associated to a service, the token comprising record data indicative of the interaction and verification data to verify the record data;
communicating the token to the user device; and
storing the token at the service device,
wherein the verification data is generated on the basis of the record data and identification data associated to the user.

2. The method of claim 1, comprising:
receiving a message from the user device, the message comprising a request to perform an action on data stored by the service and a token;
verifying the request;
accessing data stored by the service on the basis of record data contained in the token; and
performing the action according to the request.

3. The method of claim 2, wherein the request comprises authentication data authenticating the request.

4. The method of claim 3, wherein verifying the request comprises verifying the authentication data.

5. The method of claim 2, wherein the action comprises communicating data to the user device and/or deleting data stored by the service and associated to the interaction.

6. The method of claim 1, comprising:
transmitting an initiation message to the user device; and
generating the token on the basis of a response to the initiation message.

7. The method of claim 1, wherein the token comprises a uniform resource locator to locate data stored by the service associated to an interaction between the user device and service device.

8. An apparatus comprising:
a network interface to communicate data between the apparatus and a user device;
a token generator to generate tokens comprising records of communication sessions with the apparatus, and attestation data to validate the records of the communication sessions; and
a controller, communicatively coupled to the token generator and network interface, to:
transmit tokens to the user device in response to communication sessions between the apparatus and the user device; and
store tokens with session data associated to communication sessions.

9. The apparatus of claim 8, wherein the controller is to:
identify tokens from messages received in communication sessions;
identify session data associated to communication sessions; and
perform actions on session data according to requests communicated from the user device.

10. The apparatus of claim 9, wherein the requests comprise requests to communicate session data to the user device and/or delete session data.

11. A non-transitory machine-readable storage medium encoded with instructions executable by a processor, to:
identify, from data received at a first device, a token comprising log data indicative of an interaction between the first device and a second device, and verification data;
verify the log data on the basis of the verification data; and
store the token at the first device,
wherein the verification data is generated on the basis of the log data and identification data associated to the first device.

12. The storage medium of claim 11, comprising instructions to:
access a token stored at the first device, on the basis of log data associated to an interaction between the first and second device,
transmit the token with a request to perform an action on data stored by the second device in respect of the interaction between the first and second device.

13. The storage medium of claim 11, comprising instructions to:
generate authentication data on the basis of the token; and
communicate the authentication data to the second device with the request.

14. The storage medium of claim 13, wherein the identification data associated to the first device comprises a public key of the first device.

15. The storage medium of claim 14, wherein the authentication data comprises a digital signature generated on the basis of a private key associated to the public key of the first device.
